(19) United States
(12) Patent Application Publication
(10) Pub. No.: US 2013/0184157 A1
(43) Pub. Date: Jul. 18, 2013

(54) Improved Processes for the Control of Undesired Vegetative Growth In Crops

(71) Applicants: Timothy Edward Kunkel, Yuma, AZ (US); Tak Wai Cheung, Yuma, AZ (US); John Edmonds, Great Shelford (GB); Jacques Laurent Ansiaux, Jette Bruxelles (BE); George David Newberry, Boise, ID (US); Gary Louis Melchior, Walla Walla, WA (US); Frank Rene Miranda, Holtville, CA (US); Francesca Borgo, Lainate (IT)

(72) Inventors: Timothy Edward Kunkel, Yuma, AZ (US); Tak Wai Cheung, Yuma, AZ (US); John Edmonds, Great Shelford (GB); Jacques Laurent Ansiaux, Jette Bruxelles (BE); George David Newberry, Boise, ID (US); Gary Louis Melchior, Walla Walla, WA (US); Frank Rene Miranda, Holtville, CA (US); Francesca Borgo, Lainate (IT)

(73) Assignee: Gowan Comercio International E Servicos Limitada, Funcha Madeira (PT)

(21) Appl. No.: 13/813,090

(22) PCT Filed: Aug. 16, 2011
(86) PCT No.: PCT/US11/47919

§ 371 Date: Mar. 27, 2013

Related U.S. Application Data
(60) Provisional application No. 61/374,819, filed on Aug. 18, 2010.

(51) Int. Cl. A01N 25/32

(52) U.S. Cl. CPC A01N 25/32
USPC 504/300

(57) ABSTRACT

Disclosed are compositions comprising a microencapsulated triallate compound, and an improved process for the control of undesired vegetative growth in and among desired vegetative growth, especially cereal crops, the process comprising the steps of: providing an effective amount of a treatment composition to the treated crop.

The present invention relates to improved processes for the control of undesired vegetative growth in and among crops.

In an aspect, the present invention provides an improved process for the control of undesired vegetative growth in and among desired vegetative growth, especially cereal crops, the process comprising the steps of: providing an effective amount of a treatment composition to the cereal crop, which treatment composition includes a microencapsulated triallate compound.

While the use of triallate compounds are in and of themselves, old to the art, their use has been curbed and diminished in recent years due to ever increasing and restrictive standards from many government agencies. This is particularly true wherein the triallate is provided in a powdered or liquid composition or in another form wherein the triallate compounds may come into dermal contact with a grower or a consumer.

The attempts to provide safened forms of triallates as plant treatment compositions or as premixes or concentrates containing triallates intended to be further diluted or dispersed into a suitable carrier to thereby form plant treatment compositions have not been wholly successful. Emulsifiable concentrate forms of triallates are known to be commercially available, and while such reduce the risk of dermal contact with a grower or consumer, such emulsifiable concentrate forms are not without shortcomings as well. Even when dispersed into a larger volume of water, such as is typically used to form a tank-mix, the triallate compounds are still present and when dispensed onto a crop or plot of land upon which a crop is to be grown, the available triallate still poses a potential, albeit reduced, risk of exposure to humans and dermal contact. Microencapsulation technologies have been considered as being potentially useful, wherein the triallate compounds would be contained within polymeric microcapsules however such have not been consistently successful. This is believed to be attributed to the fact that triallates exhibit very poor solubility in water, the overwhelmingly present constituent of a conventional tank-mix composition and the triallates remain primarily within the microcapsules and do not become available to the environment, viz., the surface of a plant or a crop or plot upon which a crop is to be grown, until the polymeric microcapsule shell is breached or broken, thereby releasing the triallate compounds.

Recently the art has proposed in PCT/EP2008/005271 (WO 2009/000545 A2) agropharmaceutical products and a process useful for modulating the release rate of microencapsulated active ingredients, wherein the process comprises the steps of:

(I) preparation of an aqueous suspension, component (A), comprising microcapsules of at least one active ingredient,

(II) preparation of a liquid emulsifiable in water, component (B), comprising a water immiscible organic solvent of the active ingredient and at least one surfactant,

(III) as component (C), water, for diluting to the application dose the active ingredient, and

(IV) mixing of (A), (B) and (C).

Although the text of PCT/EP2008/005271 mentions, amidst a list of potentially useful active ingredients, triallates, and also mentions at pages 6-7 a myriad of potentially useful solvents, the balance of the disclosure of that document fails to demonstrate any particular product which contains as an active ingredient, triallates, and also fails to specify with a reasonable degree of particularity useful water immiscible organic solvents or the polymers useful in producing the encapsulant of the microencapsulated triallates. Pertinently, PCT/EP2008/005271 indicates that the release rate of the microencapsulated active ingredient depends upon the type and the amount of the solvent of step (II). Also, very pertinently the text of PCT/EP2008/005271 fails to demonstrate any herbidical efficacy against undesired vegetative growth other than Matricaria camomilla, Veronica hederaefolia and Papaver rhoeas which efficacy is based on a product based on encapsulated oxyfluorfen, or the efficacy of any herbidical preparations against undesired vegetative growth other than Rumex acetosa and Allium tuberosum which efficacy is based products based on encapsulated oxyfluorfen, and/or pendimethalin. Thus the text of PCT/EP2008/005271 is devoid of any specific demonstration of herbidical efficacy of microencapsulated triallate based products against any other species of undesired vegetative growth.

The inventors have surprisingly found that by judicious selection of the materials useful in preparing a product which may be produced according to the process steps outlined in PCT/EP2008/005271, there may be produced microencapsulated triallate compounds which provide a superior benefit in the control of undesired vegetative growth, especially efficacy against one or more species of wild oats (genus Avena, e.g., Avena barbata, Avena brevis, Avena fatua, Avena occidentalis, Avena pubescens, Avena pratensis, Avena spicata, Avena sterilis) and species of ryegrass (genus Lolium, e.g., Lolium canariense, Lolium edwardii, Lolium multiflorum, Lolium perenne, Lolium persicum, Lolium remotum, Lolium rigidum, Lolium temulentum) in and amongst crops, including sugar beets, and cereal grain crops, particularly wheat crops and barley crops. The compositions and treatment methods according to the invention are also believed to be effective in controlling the incidence of Alopecurus myosuroides (also commonly referred to as “slender meadow foxtail, black grass, twitch grass and/or black twitch) amongst crops, especially cereal grain crops. The compositions and treatment methods of the invention are also believed to be effective in controlling the incidence of brome or brome grasses (e.g., genus Bromoeae, i.e., Bromus alopecuros, Bromus anomalus) amongst crops, especially cereal grain crops.

The inventors have discovered that (a) specific polymers useful in forming the microcapsules concurrently with (b) specific solvents have a significant role in ensuring the success in providing an effective control of undesired vegetative growth amongst crops, such as cereal grain crops, or sugar beet crops which are not taught or disclosed with any reasonable certainty in PCT/EP2008/005271.

The products and processes for their manufacture useful in the treatment processes according to the invention may be generally formed according to the teachings of PCT/EP2008/005271; preferred materials for the production of the products are disclosed in PCT/EP2008/005271 and/or hereinafter.

Broadly speaking, then in one aspect the present invention provides a method for the control of undesired vegetative growth by the application to a plant crop (pre-emergent, or post-emergent), plant, seed or plant part a treatment composition which comprises a mixture of components (A), (B) and (C), wherein:

Component (A) is an aqueous suspension which comprises microencapsulated triallate compound(s);

Component (B) is a water-emulsifiable liquid comprising at least one surfactant and at least one solvent of the triallate compound(s); and,

Component (C) is quantity of water which is sufficient to dilute the triallate compound(s) to a desired concentration or application rate which as is desired to be applied to the said plant crop (pre-emergent, or post-emergent), plant, seed or plant part.

As one form of a vendible product, Component (A) is provided in a separate container or vessel from a further container or vessel which is used to provide Component (B) to an end-user, who may thereafter mix Components (A) and (B) in a larger quantity of water, viz., Component (C) which may then be used directly as a plant treatment composition, or which may be subsequently further diluted with an additional quantity of water and/or water/organic solvent to form a plant treatment composition therefrom.

In component (A), the microcapsules comprise at least a triallate compound as an active ingredient. The triallate compound useful in the formation of products to be used in the inventive treatment processes is advantageously 2,3,3-trichloro-2-propene-1-thiol diisopropylcarbamate; S-(2,3,3-trichloro-2-propenyl)bis(1-methylethyl)carbamothioate, which is also commonly referred to as its common moniker, “triallate”. Such is an art-recognized herbidical active constituent (ingredient). This compound may be represented by the following structure:

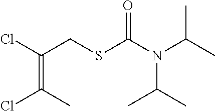 [SMILES: C/C(Cl)=C(/Cl)CSC(=O)N(C(C)C)C(C)C]

and it is known in the agricultural arts as a lipid biosynthesis inhibitor compound, useful in controlling certain classes of undesired vegetative growth, viz., as a herbicide. This compound may be supplied and used as described above, or may also be provided and used in an agronomically acceptable salt form. Also coming into consideration for use with the above triallate compounds, or in place of the above triallate compounds are analogues of triallate compounds, including certain carbamate compounds, as well as agronomically acceptable salt forms thereof which also exhibit herbicidal activity. It is also contemplated that in addition to the triallate, one or more further active constituents (described below) may be additional present within the microcapsules. However in particularly preferred embodiments, the triallate (and/or agronomically acceptable salt form thereof) are the predominant active ingredient present, and in especially preferred embodiments triallate is the sole active ingredient present within the microcapsules.

Component (A) of the invention includes microcapsules which encapsulate the active ingredient which are formed of one or more polymers or other shell forming materials. Such polymers or other materials are also referred to herein as encapsulants. The encapsulant may be a polymeric material which is insoluble in water and which may be obtained by interfacial in situ polymerization. Such polymers may be formed by polycondensation, or may be formed by other techniques or process known to the art. Examples of encapsulants include one or more polymers selected from: polyamides, polyesters, polyurethanes, polyureas as well as copolymers of one or more thereof. Preferred are encapsulants based on polyurea polymers or copolymers.

The microencapsulated active ingredient, viz, triallate, can be prepared according to known techniques or are commercially available. They usually comprise polymeric microcapsules having an average diameter from 1 to 30 microns, preferably from 2 to 20 microns. The microcapsules comprise a core of at least the active ingredient and a shell of polymeric material.

The aqueous suspension of component (A) may contain the microcapsules containing the active ingredient in any effective amount. Advantageously however, the microcapsules are suspended in water at a ratio such that the concentration of the active ingredient (“a.i.”) is up to 99% w/w, preferably from about 1-90% w/w, yet more preferably from about 5-80% w/w.

The aqueous suspension of component (A) may be formed by techniques known to the art. The aqueous suspension of component (A) may, in addition to water and the microencapsulated active ingredient, may additionally optionally include one or more further materials, e.g., further herbicides, acaricides, insecticides, fungicides, biocides, plant growth regulators, insect growth regulators, antidotes, further organic solvents (which may be the same as, or different than the aforementioned water immiscible organic solvent constituent of mixture (B)), dispersants, surfactants, excipients such as thickeners, antifoam agents, antifreeze agents, antimicrobial agents, and activity modifiers, etc. Such addition optional further materials may be present in the so-called “bulk phase”, namely the water within which the microencapsulated triallate-containing particles are suspended, and/or, although less desirably, one or more of such optional further materials may be present within the encapsulant and may be microencapsulated.

The application rate of the active ingredient of the compositions of the invention may be any amount which provides the desired degree of efficacy after the components (A) and (B) are diluted or dispersed in the water (C) or otherwise as applied to the seed, plant (pre-emergent, or post-emergent), or crop. By way of one example, the amount of water (C) used in such applications is from 10-8000 litres/hectare, more advantageously from 50-1000 litres/hectare. The application rate of the active ingredient of the compositions of the invention may also vary, for example can provide from about 0.1 gram-50 kg. per hectare, more preferably in the range of about 1-5000 g/hectare, yet more preferably between about 10 g-4000 g/hectare of the active ingredient, preferably wherein the active ingredient comprises, or consists of, or consists essentially of triallate compound(s).

Preferred application rates of the triallate, as well as application methods, are disclosed with reference to one or more of the Examples.

As briefly stated above the compositions useful in the treatment processes of the invention requires as part of component (B) a water immiscible organic solvent constituent, as well as a surfactant. Component (B) may be a water emulsifiable liquid. Preferably the water immiscible organic solvent is, by way of non-limiting example, one or more compounds selected from liquid n-paraffins, liquid iso-paraffins, cycloalkanes, naphthene-containing solvents, white spirit, kerosene, aromatic solvents, mineral turpentine, ester solvents, silicone solvents or oils, terpenes, fatty acids, paraffin waxes, linear alkyl benzene, dialkyl phthalates, C₅-C₁₁ alcohols and fatty alcohols. Specific examples of these are as follows: liquid n-paraffins such as Norpar 12, Norpar 13 and Norpar 15 (available from Exxon); liquid iso-paraffins such as Isopar G, Isopar H, Isopar L, Isopar M and Isopar V (available from Exxon); naphthene-containing solvents such as Exxsol D40, Exxsol D60, Exxsol D80, Nappar 10 (available from Exxon); ester solvents, such as alkyl acetates, examples being Exxate 1000, Exxate 1300 (available from Exxon), and Coasol (available from Chemoxy International); terpene based solvents, such as eucalyptus oil, cineole, orange oil, limonene; fatty alcohols such as octanol, decanol, lauryl alcohol, myristyl alcohol, cetyl alcohol, stearyl alcohol, cetostearyl alcohol, oleyl alcohol, and aromatic solvents such as toluene, benzene, xylene. Particularly preferred water immiscible organic solvents are liquids at room temperature, viz., 20° C.

Examples of useful water immiscible organic solvents are disclosed in PCT/EP2008/005271. Certain preferred solvents are those have one or more of the following characteristics: (i) a capability to solubilize the active ingredient, viz., triallate, at room temperature (20° C. or 25° C.) in an amount of at least 3% w/w, more preferably at least 5% w/w, yet more preferably at least 10% w/w, still more preferably at least 15% w/w, and especially preferably at least 20% w/w; (ii) exhibit little or no detrimental interaction with the polymer of the capsule, e.g., do not cause rupture or breakage or swell of the capsule (as may be measured by inspecting the capsules following 24 hours of contact time at room temperature with the solvent) ; (iii) are substantially (having an aqueous solubility of <0.5% w/w, preferably <0.1% w/w, yet more preferably <0.01% w/w) immiscible in water. Preferably the organic aromatic solvents have low volatility, preferably have a volatility according to ASTM D3539 of <0.1 (wherein according to ASTM D3539, butylacetate=1)

Nonlimiting examples of preferred water immiscible organic solvents include one or more of: C₉-C₂₀ alkylbenzenes; C₁-C₄ alkyl esters of C₃-C₁₄ dicarboxylic acids (e.g., dimethyl glutarate, dimethyl succinate, dimethyl adipate, dimethyl sebacate, diisopropyl myristate), C₃-C₁₀ alkyl esters of C₃-C₁₀ carboxylic acids or hydroxyacids (e.g., ethylhexyl lactate), methyl esters of C₁₂-C₂₂ saturated or unsaturated fatty acids (e.g., oleic acid, linoleic acid), as well as C₇-C₉ alkyl esters of acetic acid (e.g., heptylacetate).

It has been discovered that particularly preferred water immiscible organic solvents such should be selected from organic aromatic solvents. In the present invention, particularly preferred water immiscible organic aromatic solvents, are e.g., at least one aromatic organic solvent or organic solvent composition having one of the following distillation ranges and flashpoints: distillation range, 165-180° C. and flashpoint, 50° C.; distillation range, 155-181° C. and flashpoint, 50° C.; distillation range, 182-207° C. and flashpoint, 64° C.; distillation range, 183-194° C. and flashpoint, 64° C.; distillation range, 232-287° C. and flashpoint, 101° C.; and distillation range, 248-295° C. and flashpoint, 107° C. One or more of these foregoing particularly preferred water immiscible organic solvents may be present in the compositions of the invention.

The release of the triallate compound(s) of Component (A) from within the encapsulant may be controlled by increasing or decreasing the ratio of Component (B) to that of Component (A).

Component (B) also includes at least one surfactant. Non-limiting examples of surfactants useful in the plant treatment compositions of the invention include one or more of anionic, nonionic, cationic, amphoteric and zwitterionic surfactants, which can be used singly or in mixtures. Exemplary nonionic surfactants include polyoxyethylene alkyl ethers, polyoxyethylene alkyl allyl ethers, polyoxyethylene lanolin alcohols, polyoxyethylene alkyl phenol formalin condensates, polyoxyethylene sorbitan fatty acid esters, polyoxyethylene glycerol mono-fatty acid esters, polyoxypropylene glycol mono-fatty acid esters, polyoxyethylene sorbitol fatty acid esters, polyoxyethylene-castor oil derivatives, polyoxyethylene fatty acid esters, fatty acid glycerol esters, sorbitan fatty acid esters, sucrose fatty acid esters, polyoxyethylene polyoxypropylene block polymers, polyoxyethylene fatty acid amides, alkylol amides, and polyoxyethylene alkyl amines.

Non-limiting examples of useful anionic surfactants include alcohol sulfates and sulfonates, alcohol phosphates and phosphonates, alkyl ester sulfates, alkyl diphenyl ether sulfonates, alkyl sulfates, alkyl ether sulfates, sulfate esters of an alkylphenoxy polyoxyethylene ethanol, alkyl monoglyceride sulfates, alkyl sulfonates, alkyl ether sulfates, alpha-olefin sulfonates, beta-alkoxy alkane sulfonates, alkyl ether sulfonates, ethoxylated alkyl sulfonates, alkylaryl sulfonates, alkylaryl sulfates, alkyl monoglyceride sulfonates, alkyl carboxylates, alkyl ether carboxylates, alkyl alkoxy carboxylates having 1 to 5 moles of ethylene oxide, alkylpolyglycolethersulfates (containing up to 10 moles of ethylene oxide), sulfosuccinates, octoxynol or nonoxynol phosphates, taurates, fatty taurides, fatty acid amide polyoxyethylene sulfates, acyl glycerol sulfonates, fatty oleyl glycerol sulfates, alkyl phenol ethylene oxide ether sulfates, paraffin sulfonates, alkyl phosphates, isethionates, N-acyl taurates, alkyl succinamates and sulfosuccinates, alkylpolysaccharide sulfates, alkylpolyglucoside sulfates, alkyl polyethoxy carboxylates, and sarcosinates or mixtures thereof.

Further examples of anionic surfactants include water soluble salts or acids of the formula (ROSO₃)ₓM or (RSO₃)ₓM wherein R is preferably a C₆-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a mono-, di- or tri-valent cation, e. g., an alkali metal cation (e. g., sodium, potassium, lithium), or ammonium or substituted ammonium (e. g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like) and x is an integer, preferably 1 to 3, most preferably 1. Materials sold under the Hostapur and Biosoft trademarks are examples of such anionic surfactants.

Further examples of anionic surfactants include alkyl-diphenyl-ethersulphonates and alkyl-carboxylates. Other anionic surfactants can include salts (including, for example, sodium, potassium, ammonium, and substituted ammonium salts such as mono-, di-and triethanolamine salts) of soap, C₆-C₂₀ linear alkylbenzenesulfonates, C₆-C₂₂ primary or secondary alkanesulfonates, C₆-C₂₄ olefinsulfonates, sulfonated polycarboxylic acids prepared by sulfonation of the pyrolyzed product of alkaline earth metal citrates, e. g., as described in British patent specification No. 1,082,179, C₆-C₂₄ alkylpolyglycolethersulfates (containing up to 10 moles of ethylene oxide); alkyl ester sulfates such as C₁₄₋₁₆ methyl ester sulfates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), acyl sarcosinates, sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH₂CH₂O)ₖCH₂COO⁻M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678 to Laughlin, et al. at column 23, line 58 through column 29, line 23, the contents of which are herein incorporated by reference. Certain preferred useful anionic surfactants include sodium salts of fatty acids such as sodium palmitate, ether sodium carboxylates such as polyoxyethylene lauryl ether sodium carboxylate, amino acid condensates of fatty acids such as lauroyl sodium sarcosine and N-lauroyl sodium glutamate, alkylarylsulfonates such as sodium dodecylbenzenesulfonate and diisopropylnaphthalenesulfonates, fatty acid ester sulfonates such as lauric acid ester sulfonates, dialkyl sulfosuccinates such as dioctyl sulfosuccinate, ligninsulfonates, fatty acid amidosulfonates such as oleic acid amidosulfonate, formalin condensates of alkylarylsulfonates, alcohol sulfates such as pentadecane-2-sulfate, polyoxyethylene alkyl ether sulfates such as polyoxyethylene dodecyl ether sodium sulfate, polyoxyethylene alkyl phosphates such as dipolyoxyethylene dodecyl ether phosphates, styrene-maleic acid copolymers, and alkyl vinyl ether-maleic acid copolymers.

Non-limiting examples of useful amphoteric surfactants include sultaines, including compounds which may be represented by the following formula:

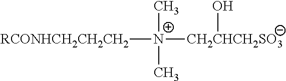

wherein in the above formulae, R represents a C₈ to C₂₄ alkyl group, and is preferably a C₁₀ to C₁₆ alkyl group. Further useful as amphoteric or zwitterionic surfactants are alkyl betaines, alkyl amidobetaines, aminopropionates, aminoglycinates, imidazolinium betaines and sulfobetaines. Within this group, alkyl betaines and alkyl amidobetaines are particularly preferred. Alkyl betaines are known surfactants which are mainly produced by carboxyalkylation, preferably carboxymethylation of aminic compounds. Typical examples are the carboxymethylation products of hexyl methyl amine, hexyl dimethyl amine, octyl dimethyl amine, decyl dimethyl amine, dodecyl methyl amine, dodecyl dimethyl amine, dodecyl ethyl methyl amine, C_{12/14} cocoalkyl dimethyl amine, myristyl dimethyl amine, cetyl dimethyl amine, stearyl dimethyl amine, stearyl ethyl methyl amine, oleyl dimethyl amine, C_{16/18} tallow alkyl dimethyl amine and technical mixtures thereof; alkyl amidobetaines which represent carboxyalkylation products of amidoamines are also suitable. Typical examples are reaction products of fatty acids containing 6 to 22 carbon atoms, namely caproic acid, caprylic acid, capric acid, lauric acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof, with N,N-dimethylaminoethyl amine, N,N-dimethylaminoproply amine, N,N-diethylaminoethyl amine and N,N-diethylaminoproply amine which are condensed with sodium chloroacetate. Further specific examples of useful amphoteric or zwitterionic surfactants include N-laurylalanine, N,N,N-trimethylaminopropionic acid, N,N,N-trihydroxyethylaminopropionic acid, N-hexyl N,N-dimethylaminoacetic acid, 1-(2-carboxyethyl)-pyridiniumbetaine, and lecithin.

Non-limiting examples of useful cationic surfactants include alkylamine hydrochlorides such as dodecylamine hydrochloride, benzethonium chloride, alkyltrimethylammoniums such as dodecyltrimethylammonium, alkyldimethylbenzylammoniums, alkylpyridiniums, alkylisoquinoliniums, dialkylmorpholiniums, and polyalkylvinylpyridiniums.

Further useful surfactants which may be used include those comprising silicon atoms, e.g., one or more polysiloxanes which are commonly used and often interchangeably referred to as silicone emulsifiers. Such silicone emulsifiers include polydiorganosiloxanepolyoxyalkylene copolymers containing at least one polydiorganosiloxane segment and at least one polyoxyalkylene segment. The polyoxyalkylene segments may be bonded to the polydiorganosiloxane segments with silicon-oxygen-carbon bonds and/or with silicon-carbon bonds. The polydiorganosiloxane segments of consist essentially of siloxane units which are interlinked by Si—O—Si linkages and which have the formula:

R_{b}SiO_{(4{b})/2}

The value of b may range from 0 to 3 for said siloxane units with the provision that there is an average of approximately 2, i.e. from 1.9 to 2.1 R radicals for every silicon in the copolymer. Suitable siloxane units thus include R₃SiO_{1/2}, R₂SiO_{2/2}, RSiO_{3/2}, and SiO_{4/2} siloxane units taken in such molar amounts so that b has an average value of approximately 2 in the copolymer. Said siloxane units may be arranged in linear, cyclic and/or branched fashion. The R radicals may be any radical selected from the group consisting of methyl, ethyl, vinyl, phenyl, and a divalent radical bonding a polyoxyalkylene segment to the polydiorganosiloxane segment. At least 95 percent of all R radicals are methyl radicals; preferably there is at least one methyl radical bonded to each silicon atom in (d). Divalent R radicals preferably contain no more than 6 carbon atoms. Examples of divalent R radicals include —O—, —CₘH₂ₘO—, —CₘH₂ₘ— and —CₘH₂ₘCO₂— where m is an integer greater than zero. Illustrative of the siloxane units that make up the polydiorganosiloxane segments are the following, where Me denotes methyl and Q denotes said divalent R radical and bonded polyoxyalkylene segment: R₃SiO_{1/2} units such as Me₃SiO_{1/2}, Me₂(CH₂═CH)SiO_{1/2}, Me₂(C₆H₅)SiO_{1/2}, Me(C₆H₅)(CH₂═CH)SiO_{1/2}, Me₂(CH₃CH₂)SiO_{1/2}, Me₂QSiO_{1/2}, MeQ₂SiO_{1/2}, Q₃SiO_{1/2}, Q₂(CH₃CH₂)SiO_{1/2}, and Me(C₆H₅)(Q)SiO_{1/2}; R₂SiO_{2/2} units such as Me₂SiO_{2/2}; Me(C₆H₅)SiO_{2/2}, Me(CH₂═CH)SiO_{2/2}, (C₆H₅)₂SiO_{2/2}, MeQSiO_{2/2}, and Q(C₆H₅)SiO_{2/2}; RSiO_{3/2} units such as MeSiO_{3/2}, C₆H₅SiO_{3/2}, CH₂═CHSiO_{3/2}, CH₃CH₂SiO_{3/2} and QSiO_{3/2}; and SiO_{4/2} units.

Volatile linear silicones including polydimethylsiloxane and dimethicones may also be present as silicone emulsifiers in compositions according to the invention.

Also useful as silicone emulsifiers in the inventive compositions are one or more compounds which may be represented by the structure:

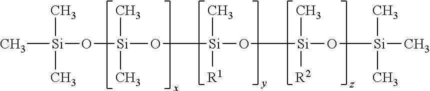

wherein

R¹ represents a C₁-C₃₀ straight chained, branched or cyclic alkyl group,

R² represents a moiety selected from:

—(CH₂)ₙ—O—(CH₂CHR³O)ₘ—H

and

—(CH₂)ₙ—O—(CH₂CHR³O)ₘ—(CH₂CHR⁴O)ₚ—H

in which n represents an integer from about 3 to about 10, R3 and R4 are selected from hydrogen and C1-C6 straight chain, or branched chain alkyl groups with the proviso that R³ and R⁴ are not simultaneously the same, each of m, p, x and y are independently selected from integers of zero or greater, such that the molecule has a molecular weight of between about 200 to about 20,000,000 and wherein both m and p are not both simultaneously zero, and z is selected from integers of 1 or greater.

When present, any of the foregoing surfactants may be present as a single surfactant or a mixture of surfactants, in any effective or desired amount. When present, any of the foregoing surfactants may be included to aid in the solubilization or dispersion of component (A) and component (B) in the water of component (C) when these component are mixed together. Advantageously however the surfactant is selected to aid in the release of the triallate from within the capsule and into the mixture of (A), (B) and (C). One or more such surfactants may be present in any amount effective to provide such a function(s). Preferred surfactants are those which increase the solubility of triallates in water, certain of which are identified with reference to one or more of the Examples.

It is to be further understood that one or more of the foregoing surfactants may also be present in component (A) as discussed above. One or more of the foregoing surfactants may also be present in component (C) as discussed following.

In certain further preferred embodiments of the invention, in the preferred products used in the treatment process of the invention, the weight ratio between the water immiscible aromatic organic solvent(s) of the mixture (B) and the triallate present in the microcapsules in the aqueous suspension (A) is in the range of from 0.01-10:1, preferably 0.1-5:1, more preferably from 0.1-2:1, and especially preferably from 0.1-1:1.

The release rate of the a.i., triallate, from within the capsules may be controlled by the proportion or ratio of component (B) with respect to that of component (A).

Mixtures of components (A) and (B) may be formed prior to the addition of water, viz., component (C). Mixtures of components (A) and (B) may be in the form of mixtures, dispersions, emulsions, or microemulsions. Subsequently, component (C) may be added to the mixture of components (A) and (B) to provide an aqueous concentrate which need be further diluted with additional water in order to provide an aqueous preparation of components (A), (B) and (C) at the desired application rate of the a.i., viz, triallate. Alternately component (A) and/or component (B) may be mixed with parts or all of component (C), in order to produce an aqueous preparation of components (A), (B) and (C) at the desired application rate of the a.i., viz, triallate.

Preferred products useful in the treatment processes of the invention include: an aqueous suspension comprising (A) microcapsules of triallate and/or an agronomically acceptable salt thereof; a (B) mixture containing (i) at least at least one water immiscible aromatic organic solvent or an organic solvent composition having one of the following distillation ranges and flashpoints: distillation range, 165-180° C. and flashpoint, 50° C.; distillation range, 155-181° C. and flashpoint, 50° C.; distillation range, 182-207° C. and flashpoint, 64° C.; distillation range, 183-194° C. and flashpoint, 64° C.; distillation range, 232-287° C. and flashpoint, 101° C.; and distillation range, 248-295° C. and flashpoint, 107° C. and (ii) at least one surfactant selected from anionic, nonionic, cationic, zwitterionic and/or amphoteric surfactants, and (C) water. In these preferred embodiments, one or more of (A), (B) and/or (C) may further optionally comprise one or more biologically active further constituents, e.g., herbicides, acaricides, insecticides, fungicides, biocides, plant growth regulators, insect growth regulators, safeners, as well as one or more non-biologically active constituents, e.g., organic solvents (which may be the same as, or different than the aforementioned preferred water immiscible organic aromatic solvents), binders, stabilizers, dyes, fragrance materials, lubricants, dispersants, surfactants, thickeners, antifoam agents, antifreeze agents, antimicrobial agents, and activity modifiers, etc. When present these one or more optional constituents may be present in effective amounts. When present these one or more optional constituents may be included in any of (A), (B) and or (C), or may be added to any treatment composition containing (A), (B) and (C). Such optional constituents may include materials which are not expressly recited in this specification, but which nonetheless would be recognized as a useful optional constituent to a skilled artisan. Such optional constituents may be included in effective amounts in the final composition which is applied.

By way of nonlimiting examples, examples of biologically active materials include materials which exhibit or provide pesticidal, disease control, including fungicidal, mildew control or herbicidal or plant growth regulating effects.

Exemplary fungicides which may be used in the plant treatment compositions of the invention include one or more of: 2-phenylphenol; 8-hydroxyquinoline sulfate; AC 382042; Ampelomyces quisqualis; Azaconazole; Azoxystrobin; Bacillus subtilis; Benalaxyl; Benomyl; Biphenyl; Bitertanol; Blasticidin-S; Bordeaux mixture; Borax; Bromuconazole; Bupirimate; Calboxin; calcium polysulfide; Captafol; Captan; Carbendazim; Carpropanmid (KTU 3616); CGA 279202; Chinomethionat; Chlorothalonil; Chlozolinate; copper hydroxide; copper naphthenate; copper oxychloride; copper sulfate; cuprous oxide; Cymoxanil; Cyproconazole; Cyprodinil; Dazomet; Debacarb; Dichlofluanid; Dichlomezine; Dichlorophen; Diclocymet; Dicloran; Diethofencarb; Difenoconazole; Difenzoquat; Difenzoquat metilsulfate; Diflumetorim; Dimethirimol; Dimethomorph; Diniconazole; Diniconazole-M; Dinobuton; Dinocap; diphnenylamine; Dithianon; Dodemorph; Dodemorph acetate; Dodine; Dodine free base; Edifenphos; Epoxiconazole (BAS 480F); Ethasulfocarb; Ethirimol; Etridiazole; Famoxadone; Fenamidone; Fenarimol; Fenbuconazole; Fenfin; Fenfuram; Fenhexamid; Fenpiclonil; Fenpropidin; Fenpropimorph; Fentin acetate; Fentin hydroxide; Ferbam; Ferimzone; Fluazinam; Fludioxonil; Fluoroimide; Fluquinconazole; Flusilazole; Flusulfamide; Flutolanil; Flutriafol; Folpet; formaldehyde; Fosetyl; Fosetyl-aluminum; Fuberidazole; Furalaxyl; Fusarium oxysporum; Gliocladium virens; Guazatine; Guazatine acetates; GY-81; hexachlorobenzene; Hexaconazole; Hymexazol; ICIA0858; IKF-916; Imazalil; Imazalil sulfate; Imibenconazole; Iminoctadine; Iminoctadine triacetate; Iminoctadine tris[Albesilate]; Ipconazole; Iprobenfos; Iprodione; Iprovalicarb; Kasugamycin; Kasugamycin hydrochloride hydrate; Kresoxim-methyl; Mancopper; Mancozeb; Maneb; Mepanipyrim; Mepronil; mercuric chloride; mercuric oxide; mercurous chloride; Metalaxyl; Metalaxyl-M; Metam; Metam-sodium; Metconazole; Methasulfocarb; methyl isothiocyanate; Metiram; Metominostrobin (SSF-126); MON65500; Myclotbutanil; Nabam; naphthenic acid; Natamycin; nickel bis(dimethyldithiocarbamate); Nitrothal-isopropyl; Nuarimol; Octhilinone; Ofurace; oleic acid (fatty acids); Oxadixyl; Oxine-copper; Oxycarboxin; Penconazole; Pencycuron; Pentachlorophenol; pentachlorophenyl laurate; Perfurazoate; phenylmercury acetate; Phlebiopsis gigantea; Phthalide; Piperalin; polyoxin B; polyoxins; Polyoxorim; potassium hydroxyquinoline sulfate; Probenazole; Prochloraz; Procymidone; Propamocarb; Propamocarb Hydrochloride; Propiconazole; Propineb; Pyrazophos; Pyributicarb; Pyrifenox; Pyrimethanil; Pyroquilon; Quinoxyfen; Quintozene; RH-7281; sec-butylamine; sodium 2-phenylphenoxide; sodium pentachlorophenoxide; Spiroxamine (KWG 4168); Streptomyces griseoviridis; sulfur; tar oils; Tebuconazole; Tecnazene; Tetraconazole; Thiabendazole; Thifluzamide; Thiophanate-methyl; Thiram; Tolclofos-methyl; Tolylfluanid; Triadimefon; Triadimenol; Triazoxide; Trichoderma harzianum; Tricyclazole; Tridemorph; Triflumizole; Triforine; Triticonzole; Validamycin; vinclozolin; zinc naphthenate; Zineb; Ziram; the compounds having the chemical name methyl (E,E)-2-(2-(1-(1-(2-pyridyl)propyloxyimino)-1-cyclopropylmethyloxymethyl)phenyl)-3-ethoxypropenoate and 3-(3,5-dichlorophenyl)-4-chloropyrazole.

When present the one or more fungicides, may be included in any effective amount, and advantageously are present in amounts of from 0.01 ppm to 50,000 ppm, preferably 10 ppm to 10,000 ppm based on total weight of the plant treatment composition of which it forms a part, as applied to the plant or soil.

Exemplary pesticides include insecticides, acaricides and nematocides, which be used singly or in mixtures in the plant treatment compositions of the invention. By way of non-limiting example such include one or more of: Abamectin; Acephate; Acetamiprid; oleic acid; Acrinathrin; Aldicarb; Alanycarb; Allethrin [(1R) isomers]; .alpha.-Cypermethrin; Amitraz; Avermectin B1 and its derivatives, Azadirachtin; Azamethiphos; Azinphos-ethyl; Azinphosmethyl; Bacillus thurigiensi; Bendiocarb; Benfuracarb; Bensultap; .beta.-cyfluthrin; .beta.-cypermethrin; Bifenazate; Bifenthrin; Bioallathrin; Bioallethrin (S-cyclopentenyl isomer); Bioresmethrin; Borax; Buprofezin; Butocarboxim; Butoxycarboxim; piperonyl butoxide; Cadusafos; Carbaryl; Carbofuran; Carbosulfan; Cartap; Cartap hydrochloride; Chordane; Chlorethoxyfos; Chlorfenapyr; Chlorfenvirnphos; Chlorfluazuron; Chlormephos; Chloropicrin; Chlorpyrifos; Chlorpyrifos-methyl; mercurous chloride; Coumaphos; Cryolite; Cryomazine; Cyanophos; calcium cyanide; sodium cyanide; Cycloprothrin; Cyfluthrin; Cyhalothrin; cypermethrin; cyphenothrin [(1R) transisomers]; Dazomet; DDT; Deltamethrin; Demeton-S-methyl; Diafenthiuron; Diazinon; ethylene dibromide; ethylene dichloride; Dichlorvos; Dicofol; Dicrotophos; Diflubenzuron; Dimethoate; Dimethylvinphos; Diofenolan; Disulfoton; DNOC; DPX-JW062 and DP; Empenthrin [(EZ)-(1R) isomers]; Endosulfan; ENT 8184; EPN; Esfenvalerate; Ethiofencarb; Ethion; Ethiprole having the chemical name 5-amino-3-cyano-1-(2,6-dichloro-4-trifluoromethylphenyl)-4-ethylsulfinylpyrazole; Ethoprophos; Etofenprox; Etoxazole; Etrimfos; Famphur; Fenamiphos; Fenitrothion; Fenobucarb; Fenoxycarb; Fenpropathrin; Fenthion; Fenvalerate; Fipronil and the compounds of the arylpyrazole family; Flucycloxuron; Flucythrinate; Flufenoxuron; Flufenprox; Flumethrin; Fluofenprox; sodium fluoride; sulfuryl fluoride; Fonofos; Formetanate; Formetanate hydrochloride; Formothion; Furathiocarb; Gamma-HCH; GY-81; Halofenozide; Heptachlor; Heptenophos; Hexaflumuron; sodium hexafluorosilicate; tar oils; petroleum oils; Hydramethylnon; hydrogen cyanide; Hydroprene; Imidacloprid; Imiprothrin; Indoxacarb; Isazofos; Isofenphos; Isoprocarb; Methyl isothiocyanal; Isoxathion; lambda-Cyhalothrin; pentachlorophenyl laurate; Lufenuron; Malathion; MB-599; Mecarbam; Methacrifos; Methamidophos; Methidathion; Methiocarb; Methomyl; Methoprene; Methoxychlor; Metolcarb; Mevinphos; Milbemectin and its derivatives; Monocrotophos; Naled; nicotine; Nitenpyram; Nithiazine; Novaluron; Omethoate; Oxamyl; Oxydemeton-methyl; Paecilomyces fumosoroseus; Parathion; Parathion-methyl; pentachlorophenol; sodium pentachlorophenoxide; Permethrin; Penothrin [(1R)-trans-isomers]; Phenthoate; Phorate; Phosalone; Phosmet; Phosphamidon; phosphine; aluminum phosphide; magnesium phosphide; zinc phosphide; Phoxim; Pirimicarb; Pirimiphos-ethyl; Pirimiphos-methyl; calcium polysulfide; Prallethrin; Profenfos; Propaphos; Propetamphos; Propoxur; Prothiofos; Pyraclofos; pyrethrins (chrysanthemates, pyrethrates, pyrethrum; Pyretrozine; Pyridaben; Pyridaphenthion; Pyrimidifen; Pyriproxyfen; Quinalphos; Resmethrin; RH-2485; Rotenone; RU 15525; Silafluofen; Sulcofuron-sodium; Sulfotep; sulfuramide; Sulprofos; Ta-fluvalinate; Tebufenozide; Tebupirimfos; Teflubenzuron; Tefluthrin; Temephos; Terbufos; Tetrachlorvinphos; Tetramethrin; Tetramethrin [(1R) isomers]; .theta.-cypermethrin; Thiametoxam; Thiocyclam; Thiocyclam hydrogen oxalate; Thiodicarb; Thiofanox; Thiometon; Tralomethrin; Transfluthrin; Triazamate; Triazophos; Trichlorfon; Triflumuron; Trimethacarb; Vamidothion; XDE-105; XMC; Xylylcarb; Zeta-cypermethrin; ZXI 8901; the compound whose chemical name is 3-acetyl-5-amino-1-[2,6-dichloro-4-(trifluoromethyl)phenyl]-2-methylsulfinylpyrazole.

When present the one or more pesticides, may be included in any effective amount, and advantageously are present in amounts of from 0.01 ppm to 50,000 ppm, preferably 10 ppm to 10,000 ppm based on total weight of the plant treatment composition of which it forms a part, particularly in final end-use concentrations of the plant treatment compositions as applied to the plant or soil.

Exemplary herbicides which may be used in the plant treatment compositions of the invention, may include one or more of: 2,3,6-TBA; 2,4-D; 2,4-D-2-ethylhexyl; 2,4-DB; 2,4-DB-butyl; 2,4-DB-dimethylammonium; 2,4-DB-isooctyl; 2,4-DB-potassium; 2,4-DB-sodium; 2,4-D-butotyl (2,4-D-Butotyl (2,4-D Butoxyethyl Ester)); 2,4-D-butyl; 2,4-D-dimethylammonium; 2,4-D-Diolamine; 2,4-D-isoctyl; 2,4-D-isopropyl; 2,4-D-sodium; 2,4-D-trolamine; Acetochlor; Acifluorfen; Acifluorfen-sodium; Aclonifen; Acrolein; AKH-7088; Alachlor; Alloxydim; Alloxydim-sodium; Ametryn; Amidosulfuron; Amitrole; ammonium sulfamate; Anilofos; Asulam; Asulam-sodium; Atrazine; Azafenidin; Azimsulfuron; Benazolin; Benazolin-ethyl; Benfluralin; Benfuresate; Benoxacor; Bensulfuron; Bensulfuron-methyl; Bensulide; Bentazone; Bentazone-sodium; Benofenap; Bifenox; Bilanofos; Bilanafos-sodium; Bispyribac-sodium; Borax; Bromacil; Bromobutide; Bromofenoxim; Bromoxynil; Bromoxynil-heptanoate; Bromoxynil-octanoate; Bromoxynil-potassium, Butachlor; Butamifos; Butralin; Butroxydim; butylate; Cafenstrole; Carbetamide; Carfentrazone-ethyl; Chlomethoxyfen; Chloramben; Chlorbromuron; Chloridazon; Chlorimuron; Chlorimuron-ethyl; Chloroacetic Acid; Chlorotoluron; Chlorpropham; Chlorsulfuron; Chlorthal; Chlorthal-dimethyl; Chlorthiamid; Cinmethylin; Cinosulfuron; Clethodim; Clodinafop; Clodinafop-Propargyl; Clomazone; Clomeprop; Clopyralid; Clopyralid-Olamine; Cloquintocet; Cloquintocet-Mexyl; Chloransulam-methyl; CPA; CPA-dimethylammonium; CPA-isoctyl; CPA-thioethyl; Cyanamide; Cyanazine; Cycloate; Cyclosulfamuron; Cycloxydim; Cyhalofop-butyl; Daimuron; Dalapon; Dalapon-sodium; Dazomet; Desmeduipham; Desmetryn; Dicamba; Dicamba-dimethylammonium; Dicamba-potassium; Dicamba-sodium; Dicamba-trolamine; Dichlobenil; Dichlormid; Dichlorprop; Dichlorprop-butotyl (Dichlorprop-butotyl (Dichlorpropbutoxyethyl ester)); Dichlorprop-dimethylammonium; Dichlorprop-isoctyl; Dichlorprop-P; Dichlorprop-potassium; Diclofop; Diclofop-methyl; Difenzoquat; Difenzoquat metilsulfate; Diflufenican; Diflufenzopyr (BAS 654 00 H); Dimefuron; Dimepiperate; Dimethachlor; Dimethametryn; Dimethenamid; Dimethipin; dimethylarsinic acid; Dinitramine; Dinoterb; Dinoterb acetate; Dinoterb-ammonium; Dinoterb-diolamine; Diphenamid; Diquat; Diquat dibromide; Dithiopyr; Diuron; DNOC; DSMA; Endothal; EPTC; Esprocarb; Ethalfluralin; Ethametsulfuron-methyl; Ethofumesate; Ethoxysulfuron; Etobenzanid; Fenchlorazole-ethyl; Fenclorim; Fenoxaprop-P; Fenoxaprop-P-ethyl; Fenuron; Fenuron-TCA; Ferrous Sulfate; Flamprop-M; Flamprop-M-Isopropyl; Flamprop-M-methyl; Flazasulfuron; Fluazifop; Fluazifop-butyl; Fluazifop-P; Fluazifop-P-butyl; Fluazolate; Fluchloralin; Flufenacet (BAS FOE 5043); Flumetsulam; Flumiclorac; Flumiclorac-Pentyl; Flumioxazin; Fluometuron; Fluoroglycofen; Fluroglycofen-ethyl; Flupaxam; Flupoxam; Flupropanate; Flupropanate-sodium; Flupyrsulfuron-methyl-sodium; Flurazole; Flurenol; Flurenol-butyl; Fluridone; Flurochloridone; Fluroxypyr; Fluroxypyr-2-Butoxy-1-methylethyl; Fluroxypyr-methyl; Flurtamone; Fluthioacet-methyl; Fluxofenim; Fomesafen; Fomesafen-sodium; Fosamine; Fosamine-ammonium; Furilazole; Glyphosate; Glufosinate; Glufosinate-ammonium; Glyphosate-ammonium; Glyphosate-isopropylammonium; Glyphosate-sodium; Glyphosate-trimesium; Halosulfuron; Halosulfuron-methyl; Haloxyfop; Haloxyfop-P-methyl; Haloxyfop-etotyl; Haloxyfop-methyl; Hexazinone; Hilanafos; Imazacluin; Imazamethabenz; Imazamox; Imazapyr; Imazapyr-isopropylammonium; Imazaquin; Imazaquin-ammonium; Imazemethabenz-methyl; Imazethapyr; Imazethapyr-ammonium; Imazosulfuron; Imizapic (AC 263,222); Indanofan; Ioxynil; Ioxynil octanoate; Ioxynil-sodium; Isoproturon; Isouron; Isoxaben; Isoxaflutole; Lactofen; Laxynel octanoate; Laxynil-sodium; Lenacil; Linuron; MCPA; MCPA-butotyl; MCPA-dimethylammonium; MCPA-isoctyl; MCPA-potassium; MCPA-sodium; MCPA-thioethyl; MCPB; MCPB-ethyl; MCPB-sodium; Mecoprop; Mecoprop-P; Mefenacet; Mefenpyr-diethyl; Mefluidide; Mesulfuron-methyl; Metam; Metamitron; Metam-sodium; Metezachlor; Methabenzthiazuron; methyl isothiocyanate; methylarsonic acid; Methyldymron; Metobenzuron; Metobromuron; Metolachlor; Metosulam; Metoxuron; Metribuzin; Metsulfuron; Molinate; Monolinuron; MPB-sodium; MSMA; Napropamide; Naptalam; Naptalam-sodium; Neburon; Nicosulfuron; nonanoic acid; Norflurazon; oleic acid (fatty acids); Orbencarb; Oryzalin; Oxabetrinil; Oxadiargyl; Oxasulfuron; Oxodiazon; Oxyfluorfen; Paraquat; Paraquat Dichloride; Pebulate; Pendimethalin; Pentachlorophenol; Pentachlorophenyl Laurate; Pentanochlor; Pentoxazone; petroleum oils; Phenmedipham; Picloram; Picloram-potassium; Piperophos; Pretilachlor; Primisulfuron; Primisulfuron-methyl; Prodiamine; Prometon; Prometryn; Propachlor; Propanil; Propaquizafop; Propazine; Propham; Propisochlor; Propyzamide; Prosulfocarb; Prosulfuron; Pyraflufen-ethyl; Pyrazasulfuron; Pyrazolynate; Pyrazosulfuron-ethyl; Pyrazoxyfen; Pyribenzoxim; Pyributicarb; Pyridate; Pyriminobac-methyl; Pyrithiobac-sodium; Quinclorac; Quinmerac; Quinofolamine; Quizalofop; Quizalofop-ethyl; Quizalofop-P; Quizalofop-P-ethyl; Quizalofop-P-Tefuryl; Rimsulfuron; Sethoxydim; Siduron; Simazine; Simetryn; sodium chlorate; sodium chloroacetate; sodium pentachlorophenoxide; sodium-Dimethylarsinate; Sulcotrione; Sulfentrazone; Sulfometuron; Sulfometuron-methyl; Sulfosulfuron; Sulfuric acid; tars; TCA-sodium; Tebutam; Tebuthiuron; Tepraluxydim (BAS 620H); Terbacil; Terbumeton; Terbuthylazine; Terbutryn; Thenylchlor; Thiazopyr; Thifensulfuron; Thifensulfuron-methyl; Thiobencarb; Tiocarbazil; Tralkoxydim; Triasulfuron; Triaziflam; Tribenuron; Tribenuron-methyl; trichloroacetic acid; Triclopyr; Triclopyr-butotyl; Triclopyr-triethylammonium; Trietazine; Trifluralin; Triflusulfuron; Triflusulfuron-methyl; Vernolate: YRC 2388.

When present the one or more herbicides, may be included in any effective amount, and advantageously are present in amounts of from 0.01 ppm to 50,000 ppm, preferably 10 ppm to 10,000 ppm based on total weight of the plant treatment composition of which it forms a part, particularly in final end-use concentrations of the plant treatment compositions as applied to the plant or soil.

Non-limiting examples of ancillary solvents useful in the plant treatment compositions of the invention include one or more of saturated aliphatic hydrocarbons such as: decane, tridecane, tetradecane, hexadecane, and octadecane; unsaturated aliphatic hydrocarbons such as 1-undecene and 1-henicosene; halogenated hydrocarbons; ketones such as acetone and methyl ethyl ketone; alcohols such as methanol, ethanol, butanol, and octanol; esters such as ethyl acetate, dimethyl phthalate, methyl laurate, ethyl palmitate, octyl acetate, dioctyl succinate, and didecyl adipate; aromatic hydrocarbons such as xylene, ethylbenzene, octadecylbenzene, dodecylnaphthalene, tridecylnaphthalene; glycols, glycol esters, and glycol ethers such as ethylene glycol, diethylene glycol, propylene glycol monomethyl ether, and ethyl cellosolve; glycerol derivatives such as glycerol and glycerol fatty acid ester; fatty acids such as oleic acid, capric acid, and enanthic acid; polyglycols such as tetraethylene glycol, polyethylene glycol, and polypropylene glycol; amides such as N,N-dimethylformamide and diethylformamide: animal and vegetable oils such as olive oil, soybean oil, colza oil, castor oil, linseed oil, rapeseed oil, cottonseed oil, palm oil, avocado oil, and shark oil; as well as mineral oils. Further as being considered useful as organic solvents include silcones and silicone fluids, including cyclic silicones (cyclomethicones) like DC 244 Fluid, DC 245 Fluid, DC 246 Fluid, DC 344 Fluid; silicone polyether like DC 190 and DC 193. Water and blends of water with one or more of the foregoing solvents are also expressly contemplated as being useful solvent constituents.

When present, any of the foregoing solvents may be present as a single organic solvent or a mixture of organic solvents, in any effective or desired amount.

One or more preservative agents may also be included. Such preservative agents are preferably water soluble or water dispersible compounds or materials, and may include compositions which include one or more of: parabens, including methyl parabens and ethyl parabens, glutaraldehyde, formaldehyde, 2-bromo-2-nitropropoane-1,3-diol, 5-chloro-2-methyl-4-isothiazolin-3-one, 2-methyl-4-isothiazoline-3-one, and mixtures thereof One exemplary composition is a combination 5-chloro-2-methyl-4-isothiazolin-3-one and 2-methyl-4-isothiazolin-3-one where the amount of either component may be present in the mixture anywhere from 0.001 to 99.99 weight percent, based on the total amount of the preservative. For reasons of availability, the most preferred preservative are those commercially available preservative comprising a mixture of 5-chloro-2-methyl-4-isothiazolin-3-one and 2-methyl-4-isothiazolin-3-one marketed under the trademark KATHON® CG/ICP as a preservative composition presently commercially available from Rohm and Haas (Philadelphia, Pa.). Further useful preservative compositions include KATHON® CG/ICP II, a further preservative composition presently commercially available from Rohm and Haas (Philadelphia, Pa.), PROXEL® which is presently commercially available from Zeneca Biocides (Wilmington, Del.), SUTTOCIDE® A which is presently commercially available from Sutton Laboratories (Chatam, N.J.) as well as TEXTAMER® 38AD which is presently commercially available from Calgon Corp. (Pittsburgh, Pa.).

When present, any of the foregoing preservative agents may be present as a single agent or mixture of such agents, in any effective or desired amount.

Non-limiting examples of UV absorbers and stabilizers which may be used in the invention are one or more of antioxidants, light stabilizers, ultraviolet stabilizers, radical scavenger, and peroxide decomposers. Examples of the antioxidant are antioxidants of phenol type, amine type, phosphorus type, and sulfur type antioxidants. Non-limiting examples of ultraviolet stabilizers include:

those of the benzotriazole type, e.g., 2-(2′-hydroxyphenyl)benzotriazoles, for example 2-(2′-hydroxy-5′-methylphenyl)-benzo-triazole, 2-(3′,5′-di-tert-butyl-2′-hydroxyphenyl)benzotriazole, 2-(5′-tert-butyl-T-hydroxyphenyl)benzo-triazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole;

those of the benzophenone type, e.g., 2-hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives thereof;

esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate;

those of the cyanoacrylate type, e.g., ethyl α-cyano-β,β-diphenylacrylate, isooctyl α-cyano-β,β-diphenylacrylate, N-(β-carbomethoxy(3-cyanovinyl)-2-methylindoline;

nickel compounds, for example nickel complexes of 2,2′-thio-bis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate;

sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydrooxy-2-methylpropoxy)-4-octadecanoyloxy-2,2,6,6-tetramethylpiperidine, 5-(2-ethylhexanoyl)-oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis-[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino-)-s-triazine, 1,3,5-tris(N-cyclohexyl-N-(1,2,2,6,6-pentamethylpiperazine-3-one-4-yl)-am-ino)-s-triazine;

oxamides, e.g., 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides;

2-(2-(2-hydroxyphenyl)-1,3,5-triazines, e.g., 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine-, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazin-e, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-tr-iazine, 2-[2-hydroxy-4-(2-hydroxy-3-butyloxypropoxy)phenyl]-4,6-bis(2,4-di-methyl)-1,3,5-triazine,

Further, isopropyl acid phosphate, liquid paraffin, and epoxidized vegetable oils like epoxidized soybean oil, linseed oil, and colza oil may also be used as the stabilizer.

When present, any of the foregoing stabilizers may be present as a single stabilizer or a mixture of stabilizers, in any effective or desired amount.

An effective amount of a pH adjusting agent, e.g, one or more organic acids, one or more inorganic acids, or one or more caustic or bases may also be present in order to adjust and/or maintain the pH of a composition within a desired pH range.

Each of the foregoing non-biologically active materials which may be individually included in effective amounts. The total amounts of the one or more non-biologically active materials may be as little as 0.001% wt., to as much as 99.999% wt., based on the total weight of the plant treatment composition of which said non-biologically active materials form a part, particularly in final end-use concentrations of the plant treatment compositions as applied to the plant or soil.

The suspensions (A) may be formed by any of the techniques outlined in PCT/EP2008/005271, WO 2006/111553 or WO 2007/039055, the contents of each of which are herein wholly incorporated by reference.

One process for the formation of the compositions of the invention is generally described in the following.

Treatment compositions are formed by combining (A), (B) with (C) to a desired application rate, wherein the treatment compositions may be applied to a cereal crop, preferably a wheat crop. The treatment compositions to be used in the treatment processes of the invention may be provided in variety of forms. Advantageously the treatment compositions are largely aqueous “tank mixes” which contain (A), (B) with (C) which may optionally include further compositions or compounds, including but not limited to biologically active materials and non-biologically active materials, wherein the amount of (A) and (B) are present by controlled dilution with (C) to a desired application rate, which treatment compositions are thereafter sprayed. Additional amounts of solvents or carriers, e.g., water or a large volume of water containing a smaller volume of one or more organic solvents may be added to the combination of (A), (B) and (C).

The treatment compositions may be applied in any conventional manner, utilizing known art application equipment, techniques and frequencies of application. The treatment compositions treatment compositions of the invention can be applied to the seed, soil, pre-emergence, as well as post-emergence such as directly onto immature or mature plants, preferably in order to control the incidence of undesired vegetative growth, and especially preferably to control the incidence of undesired species of wild oats (genus Avena, e.g., Avena barbata, Avena brevis, Avena fatua, Avena occidentalis, Avena pubescens, Avena pratensis, Avena spicata, Avena sterilis) and species of ryegrass (genus Lolium, e.g., Lolium canariense, Lolium edwardii, Lolium multiflorum, Lolium perenne, Lolium persicum, Lolium remotum, Lolium rigidum, Lolium temulentum) in and/or amongst cereal grain crops, particularly wheat crops.

The compositions and treatment methods according to the invention are also believed to be effective in controlling the incidence of Alopecurus myosuroides (also commonly referred to as “slender meadow foxtail, black grass, twitch grass and/or black twitch) amongst crops, especially cereal crops. The compositions and treatment methods of the invention are also believed to be effective in controlling the incidence of brome or brome grasses (e.g., genus Bromoeae, i.e., Bromus alopecuros, Bromus anomalus, Bromus arenarius, Bromus arizonicus, Bromus arvensis, Bromus benekii, Bromus berteronaus, Bromus biebersteinii, Bromus brixiformis, Bromus bromodeus, Bromus carinatus, Bromus catharicus, Bromus ciliatus, Bromus commutatus, Bromus danthoniae, Bromus diandrus, Bromus erectus, Bromus exaltatus, Bromus fibrosus, Bromus frigidus, Bromus frondosus, Bromus grandis, Bromus grossus, Bromus hordeacus, Bromus inermis, Bromus interruptus, Bromus japonicus, Bromus kalmii, Bromus kinabaluensis, Bromus koeieanus, Bromus kopetdagensis, Bromus laevipes, Bromus lanatipes, Bromus lanceolatus, Bromus lepidus, Bromus luzonensis, Bromus macrostachys, Bromus madritensis, Bromus mango, Bromus marginatus, Bromus maritimus, Bromus mucroglumis, Bromus nottowayanus, Bromus orcuttianus, Bromus pacificus, Bromus polyanthus, Bromus porteri, Bromus pseudolaevipes, Bromus pseudosecalinus, Bromus pseudothominii, Bromus pubescens, Bromus ramosus, Bromus rigidus, Bromus scoparius, Bromus secalinus, Bromus stichensis, Bromus squarrosus, Bromus stamineus, Bromus sterilis, Bromus suksdorfii, Bromus tectorum, Bromus texensis, Bromus vulgaris, and Bromus willdenowii) an and/or amongst crops, especially cereal crops.

The inventors have also surprisingly observed that concomitant with the use of the treatment compositions in the treatment processes of the invention, there is a reduced toxicological risk to the environment as well as to workers involved in the application of the treatment compositions to soil or crops. This is believed due to the microencapsulation of the triallate. However, after (A) and (B) are mixed with (C) water to form a treatment composition, and applied either to the soil or crop or undesired vegetative growth, the herbicidal activity of the applied treatment composition compares favorably from a performance standpoint to prior art treatment compositions which comprise non-microencapsulated triallates, e.g., emulsions. Thus, the use of a treatment composition containing the aqueous suspension (A) comprising microcapsules of triallate and/or an agronomically acceptable salt thereof; a (B) the mixture containing at least one of the preferred organic aromatic solvents and at least one solvent with (C) water appears to provide a safening benefit as well.

While not wishing to be bound by the following hypothesis, the efficacy of the treatment compositions of the invention is believed to at least, in part, to be due to an expectation that the triallate compound(s) which come into contact with a part of an undesired plant improves the transmission of the triallate compound(s) and/or any other further active constituents through the wax or cuticle layer of the plant which aids in their delivery to the plant or plant part. Such improves the efficacy of the triallate compound(s) and/or any other further active constituents, permitting for their usage in lower relative dosages of active weights per application while maintaining at least comparable efficacy. Furthermore wherein the application of a treatment composition according to the invention is part of, e.g. a step of, a more expansive treatment regimen wherein other further active constituents may be applied to a plant, plant part, crop (which application may be pre-emergent, or post-emergent) the prior or concurrent application of triallate is expected to provide for improved delivery of the one or more further active constituents through the wax or cuticle layer which has been breached or diminished by the triallate.

The following examples further illustrate non-limiting examples of the present invention. It should be understood, however, that the invention is not limited solely to the particular examples given below.

### EXAMPLES

### Plant Treatment Composition:

A plant treatment composition containing microencapsulated triallate is formed according to the disclosure of using the following constituents and within the following weight ranges of each as indicated on Table 1; except where otherwise indicated, the constituents were used “as supplied” from a commercial source/commercial supplier:

TABLE 1

| | % wt. |
|---|---|
| Triallate (95-98% wt. actives) | 40-43 |
| Organic aromatic solvent, flashpoint at least 100° C. | 5-6.5 |
| Urea polymer | 4-6 |
| Sodium ligninsulfonate | 0.5-1.5 |
| Nonionic ethoxylated/propoxylated surfactant | 0.05-0.5 |
| Ethoxylated castor oil | 0.1-0.5 |
| Antifreezing constituent | <7 |
| Antifoaming constituent | <2 |
| Gum thickening agent | <0.25 |
| Antimicrobial agent | <0.25 |
| Water | q.s. |

The foregoing composition comprised microencapsulated triallate, an organic aromatic solvent and several surfactants, as well as further optional constituents. The composition of Table 1 describes a mixture of components (A) and (B) which was formed according to the technique outlined in PCT/EP2008/005271. The urea polymer was used as the encapsulant. The foregoing composition from Table 1 demonstrates a mixture of component (A) and component (B) prior to being further diluted with component (C) to form a treatment composition.

### Plant Treatment Compositions E1, E2 and Field Testing:

The foregoing composition of Table 1 was further diluted/dispersed into a larger volume of water, component (C), to form a “tank mix” plant treatment composition, a first plant treatment composition “E1” wherein the ultimate dosage of the triallate was 0.9 lbs./acre and a second plant treatment composition “E2”, wherein the dosage of the triallate was 1.25 lbs./acre.

Each of E1 and E2 were subjected to the following field use testing, which demonstrated the efficacy of the E1 and E2 treatment compositions in the control of species of wild oats and species of Italian ryegrass.

A single field, recently planted with spring wheat (Triticum sestivum) was used to evaluate the efficacy of E1 and E2 treatment compositions on the control of Italian ryegrass (Lolium multiflorum), and wild oats (Avena fatua) wherein the field was divided into adjacent zones upon which were applied the E1 and E2 treatment compositions. An untreated zone “ZC” was also present and provided an “untreated control” against which the efficacy of the E1 and E2 treatment compositions could be measured on a relative percentage basis. Applications of all compositions was performed using a pressurized backpack sprayer. In a first zone, “Z1”, the E1 treatment composition was applied directly to the soil to the planted, but preemergent spring wheat. In a second zone, “Z2”, the E1 treatment composition was applied directly to the soil to the planted, but preemergent spring wheat and this zone was later harrowed to a depth of approx. 2-3 cm, thereby ensuring good mixing of the E1 composition into the soil. Similarly in third zone, “Z3”, the E1 treatment composition was applied directly to the soil to the planted, but preemergent spring wheat. In a fourth zone, “Z4”, the E2 treatment composition was applied directly to the soil to the planted, and preemergent spring wheat and this zone was shortly thereafter harrowed to a depth of approx. 2-3 cm, thereby ensuring good mixing of the E2 composition into the soil. No further applications of either E1 or E2 were thereafter applied to any part of the field used in the test.

At 23 days and at 30 days following application of the E1 and E2 treatment compositions, the incidence of Italian ryegrass and the incidence of wild oats within each of the treated zones was evaluated, and compared to the incidence of the Italian ryegrass and the incidence of wild oats in the untreated zone. The relative degree of control of the undesired Italian ryegrass and of the undesired wild oats within each zone was evaluated by a skilled evaluator by comparison to the incidence of each in the untreated control zone “ZC”, and the results are reported on Table A, following:

TABLE A

| | | |
|---|---|---|
| | 23 days after | 30 days after |
| Zone, Treatment | application | application |
| Composition | % control | % control |

Control of Italian ryegrass

| | | |
|---|---|---|
| ZC, none | 0 | 0 |
| Z1, E1 | 43.3 | 63.3 |
| Z2, E1 | 73.3 | 86.7 |
| Z3, E2 | 56.7 | 80.0 |
| Z4, E2 | 85 | 91.7 |

Control of wild oats

| | | |
|---|---|---|
| ZC, none | 0 | 0 |
| Z1, E1 | 36.7 | 53.3 |
| Z2, E1 | 56.7 | 83.3 |
| Z3, E2 | 43.3 | 76.7 |
| Z4, E2 | 50.0 | 90.0 |

In the foregoing table, the reported results indicate the “% control” relative to the untreated control zone, which was assigned a “% control” of zero.

As is evident from the above, the treatment regimen applied to the field exhibited excellent control of undesired vegetative growth, here, Italian ryegrass and wild oats. Better results are generally observed when the treated zones were harrowed shortly after application of a treatment composition, E1 or E2, as distribution of the specific treatment composition within the soil was assured.

### Plant Treatment Compositions E3-E7, Comparative, and Field Testing:

The foregoing composition of Table 1 was further diluted/dispersed into a larger volume of water, component (C), to form several different “tank mix” plant treatment compositions, several of which additionally comprised a one or more further active constituents (described below) which were present in addition to the microencapsulated triallate compounds. When present such further constituents were provided as a separate composition than the composition of Table 1 and was added to the water of the tank mix. The following Table 2 identifies the calculated concentration of the dosage of the triallate, and where applicable, the dosage of any further identified active constituents which were also present, each on an “actives” weight basis/hectare of the tank mix.

TABLE 2

| | |
|---|---|
| E3 | Aqueous tank mix of composition of Table 1, dosed at 1620 grams |
| | triallate compounds per hectare |
| E4 | Aqueous tank mix of composition of Table 1, dosed at 1620 grams |
| | triallate compounds per hectare |
| E5 | Aqueous tank mix of composition of Table 1, dosed at 1620 grams |
| | triallate compounds per hectare, with flufenacet (supplied as Tiara ®, |
| | ex. Bayer Crop Science) dosed at 240 grams flufenacet per hectare |
| E6 | Aqueous tank mix of composition of Table 1, dosed at 1620 grams |
| | triallate compounds per hectare, with microencapsulated pedimethalin |
| | (supplied as Stomp ® Aqua, ex. BASF) dosed at 800 grams |
| | pedimethalin/hectare |
| E7 | Aqueous tank mix of composition of Table 1, dosed at 1620 grams |
| | triallate compounds per hectare, with microencapsulated pedimethalin |
| | (supplied as Stomp ® Aqua, ex. BASF) dosed at 800 grams |
| | pedimethalin/hectare |

Each of foregoing tank mix compositions were subjected to the following field use testing, which demonstrated their efficacy in the control of “black grass” (Alopecurus myosuroides) in a field sown with winter wheat (Triticum aestivum).

A single field, recently planted with winter wheat (Triticum aestivum) was used. The field was divided into adjacent zones upon which were applied the E3-E7 treatment compositions. An untreated zone “ZC” was also present and provided an “untreated control” against which the efficacy of the E3-E7 treatment compositions could be measured on a relative percentage basis. Applications of all compositions was performed using a pressurized backpack sprayer. In a first zone, “Z1”, the E3 treatment composition was applied directly to the soil to the planted, but preemergent winter wheat. In a second zone, “Z2”, the E4 treatment composition was applied directly to the soil to the planted, but preemergent winter wheat and this zone was later harrowed to a depth of approx. 2-3 cm, thereby ensuring good mixing of the E4 composition into the soil. Similarly in third zone, “Z3”, the E5 treatment composition was applied directly to the soil to the planted, but preemergent winter wheat. In a fourth zone, “Z4”, the E6 treatment composition was applied directly to the soil to the planted, but preemergent winter wheat and this zone was later harrowed to a depth of approx. 2-3 cm, thereby ensuring good mixing of the E6 composition into the soil. In a fifth zone, “Z5”, the E7 treatment composition was applied directly to the soil to the planted, but preemergent winter wheat. No further applications of any further treatment compositions were applied to any part of the field during the duration of the test.

At 119 days and at 228 days following application of the E3-E7 treatment compositions, the incidence of “black grass” (Alopecurus myosuroides) within each of the treated zones was evaluated, and compared to the incidence of “black grass” in the untreated zone. The relative degree of control of the undesired “black grass” within each zone was evaluated by a skilled evaluator by comparison to the incidence of each in the untreated control zone “ZC”, and the results are reported on Table B, following:

TABLE B
Control of “black grass”

| | 119 days after | 228 days after |
|---|---|---|
| Zone, Treatment | application | application |
| Composition | % control | % control |
| ZC, none | 0 | 0 |
| Z1, E3 | 45.1 | 28.7 |
| Z2, E4 | 17.1 | −11.7* |
| Z3, E5 | 50.6 | 56.6 |
| Z4, E6 | 40.2 | 11.9 |
| Z5, E7 | 31.1 | 23.3 |

*this reported result is believed to be anomalous

As can be seen from Table B, the E3-E7 compositions provided excellent control with improved control being observed when the microencapsulated triallate compounds were applied concurrently with one or more further different active constituents as indicated.

The compositions of E3-E7 were tested in a further field in order to further evaluate their efficacy in the control of “black grass” (Alopecurus myosuroides) in a field sown with winter wheat (Triticum aestivum). This further field was divided into adjacent zones upon which were applied the E3-E7 treatment compositions. An untreated zone “ZC” was also present and provided an “untreated control” against which the efficacy of the E3-E7 treatment compositions could be measured on a relative percentage basis. In a first zone, “Z6”, the E3 treatment composition was applied directly to the soil to the planted, but preemergent winter wheat. In a second zone, “Z7”, the E4 treatment composition was applied directly to the soil to the planted, but preemergent winter wheat and this zone was later harrowed to a depth of approx. 2-3 cm, thereby ensuring good mixing of the E4 composition into the soil. Similarly in third zone, “Z8”, the E5 treatment composition was applied directly to the soil to the planted, but preemergent winter wheat. In a fourth zone, “Z9”, the E6 treatment composition was applied directly to the soil to the planted, but preemergent winter wheat and this zone was later harrowed to a depth of approx. 2-3 cm, thereby ensuring good mixing of the E6 composition into the soil. In a fifth zone, “Z10”, the E7 treatment composition was applied directly to the soil to the planted, but preemergent winter wheat. No further applications of any further treatment compositions were applied to any part of the field during the duration of the test.

At 136 days and at 206 days following application of the E3-E7 treatment compositions, the incidence of “black grass” (Alopecurus myosuroides) within each of the treated zones was evaluated, and compared to the incidence of “black grass” in the untreated zone. The relative degree of control of the undesired “black grass” within each zone was evaluated by a skilled evaluator by comparison to the incidence of each in the untreated control zone “ZC”, and the results are reported on Table C, following:

TABLE C
Control of “black grass”

| | 136 days after | 206 days after |
|---|---|---|
| Zone, Treatment | application | application |
| Composition | % control | % control |
| ZC, none | 0 | 0 |
| Z6, E3 | 88.7 | 39.4 |
| Z7, E4 | 80.9 | 80.7 |
| Z8, E5 | 99.1 | 100 |
| Z9, E6 | 88.7 | 75.2 |
| Z10, E7 | 93.0 | 98.2 |

*this reported result is believed to be anomalous

As can be seen from Table C, the E3-E7 compositions provided excellent control with improved control being observed when the microencapsulated triallate compounds were applied concurrently with one or more further different active constituents as indicated.

### Plant Treatment Compositions E3, E8 and Field Testing:

The foregoing composition of Table 1 was further diluted/dispersed into a larger volume of water, component (C), to form a “tank mix” plant treatment composition, a first plant treatment composition “E3” wherein the ultimate dosage of the triallate was 1620 grams/hectare (as previously described) and a second plant treatment composition “E8”, wherein the dosage of the triallate was 1440 grams/hectare.

Each of E1 and E2 were subjected to the following regimens of field use testing, which demonstrated the efficacy of the E3 and E8 treatment compositions in the control of species of undesired vegetative growth amongst winter barley crops and sugar beet crops.

A single field, recently planted with winter barley was used to evaluate the efficacy of E3 and E8 treatment compositions on the control of “black grass” (Alopecurus myosuroides) in a field recently sown with winter wheat. Applications of all compositions were performed using a pressurized backpack sprayer. The field was divided into adjacent zones upon which were applied the E3 and E8 treatment compositions. An untreated zone “ZC” was also present and provided an “untreated control” against which the efficacy of the E3 and E8 treatment compositions could be measured on a relative percentage basis. In a first zone, “Z1”, and a second zone, “Z2”, the E8 treatment composition was applied directly to the soil to the planted, but preemergent winter barley. In a third and fourth zones, respectively “Z3”, and “Z4” the E3 treatment composition was applied directly to the soil to the planted, but preemergent winter barley. Zones A1-Z4 were used to evaluate the efficacy of the respective E3 and E8 tank mix compositions (treatment compositions) against of “black grass” (Alopecurus myosuroides), as compared to the untreated zone “ZC”. The results of the test are reported on the following Table D.

In a further field, recently planted with winter barley was used to evaluate the efficacy of E3 and E8 treatment compositions on the control of ryegrass (Lolium multiflorum) in a field recently sown with winter wheat. Applications of all compositions were performed using a pressurized backpack sprayer. The field was divided into adjacent zones upon which were applied the E3 and E8 treatment compositions. An untreated zone “ZC” was also present and provided an “untreated control” against which the efficacy of the E3 and E8 treatment compositions could be measured on a relative percentage basis. In a first zone, “Z5”, and a second zone, “Z6”, the E8 treatment composition was applied directly to the soil to the planted, but preemergent winter barley. In a third and fourth zones, respectively “Z7”, and “Z8” the E3 treatment composition was applied directly to the soil to the planted, but preemergent winter barley. Zones Z5-Z8 were used to evaluate the efficacy of the respective E3 and E8 tank mix compositions (treatment compositions) against ryegrass (Lolium multiflorum) as compared to the untreated zone “ZC”. The results of the test are also reported on the following Table D.

The relative degree of control of the undesired ryegrass and against the undesired “black grass” in the winter barley crop was evaluated by a skilled evaluator by comparison to the incidence of each in the untreated control zone “ZC”, and the results are reported on Table D, following:

TABLE D

| Zone, Treatment | |
|---|---|
| Composition | |
| | Control of “black |
| | grass” |
| | % control |
| ZC, none | 0 |
| Z1, E8 | 70 |
| Z2, E8 | 22 |
| Z3, E3 | 80 |
| Z4, E4 | 31 |
| | Control of |
| | ryegrass |
| | % control |
| ZC, none | 0 |
| Z5, E8 | 38 |
| Z6, E8 | 89 |
| Z7, E3 | 62 |
| Z8, E3 | 91 |

In the foregoing table, the reported results indicate the “% control” relative to the untreated control zone, which was assigned a “% control” of zero.

As is evident from the above, the treatment regimen applied to the field exhibited excellent control of undesired vegetative growth, here, ryegrass and “black grass” present in a crop of winter barley.

A single field, recently planted with sugar beets was used to evaluate the efficacy of E3 treatment compositions on the control of “winter wild oats” (Avena steriliss). Applications of all compositions were performed using a pressurized backpack sprayer. The field was divided into adjacent zones upon which were applied the E3 treatment compositions. An untreated zone “ZC” was also present and provided an “untreated control” against which the efficacy of the E3 treatment compositions could be measured on a relative percentage basis. In each of the zones, “Z1”, “Z2”, “Z3” and “Z4” the E3 treatment composition was applied directly to the soil. The results of the test are reported on the following Table E.

TABLE E

| | Control of |
|---|---|
| Zone, Treatment | “winter wild oats” |
| Composition | % control |
| ZC, none | 0 |
| Z1, E3 | 55 |
| Z2, E3 | 63 |
| Z3, E3 | 95 |
| Z4, E3 | 98 |

As is evident from the above, the treatment regimen applied to the field exhibited excellent control of undesired vegetative growth, here, ‘wild winter oats” present in a crop of sugar beets.

1. A process for controlling undesired vegetative growth in crops, preferably cereal grain crops, the process comprising the steps of:
providing as component (A) a suspension comprising microcapsules of a triallate compound, and
providing as component (B) a preparation of a liquid emulsifiable in water, comprising a water immiscible organic solvent of the triallate compound and at least one surfactant,
forming a treatment composition by adding both component (A) and (B) to a larger quantity of, component (C), water,
thereafter applying the treatment composition which comprises components (A), (B) and (C) to pre-emergent or post-emergent crops in order to provide a herbicidally effective amount of the triallate compound to control the incidence of undesired vegetative growth amongst crops, such as cereal grain crops, or sugar beet crops.

2. The process according to claim 1 wherein the microcapsules comprise a urea polymer as an encapsulant.

3. The process according to claim 1 wherein the water immiscible organic solvent is at least one aromatic organic solvent or organic solvent composition having one of the following distillation ranges and flashpoints:
a) distillation range, 165-180° C. and flashpoint, 50° C.;
b) distillation range, 155-181° C. and flashpoint, 50° C.;
c) distillation range, 182-207° C. and flashpoint, 64° C.;
d) distillation range, 183-194° C. and flashpoint, 64° C.;
e) distillation range, 232-287° C. and flashpoint, 101° C.; and
f) distillation range, 248-295° C. and flashpoint, 107° C.

4. The process according to claim 1, wherein the surfactant is a nonionic surfactant.

5. The process according to claim 1 wherein the undesired vegetative growth is one or more species of wild oats (genus Avena, e.g., Avena barbata, Avena brevis, Avena fatua, Avena occidentalis, Avena pubescens, Avena pratensis, Avena spicata, Avena sterilis); or, one or more species of ryegrass (genus Lolium, e.g., Lolium canariense, Lolium edwardii, Lolium multiflorum, Lolium perenne, Lolium persicum, Lolium remotum, Lolium rigidum, Lolium temulentum); or, one or more species of Alopecurus myosuroides; or, one or more species of brome or brome grasses (e.g., genus Bromoeae, i.e., Bromus alopecuros, Bromus anomalus).

6. The process according to claim 2 wherein the water immiscible organic solvent is at least one aromatic organic solvent or organic solvent composition having one of the following distillation ranges and flashpoints:
a) distillation range, 165-180° C. and flashpoint, 50° C.;
b) distillation range, 155-181° C. and flashpoint, 50° C.;
c) distillation range, 182-207° C. and flashpoint, 64° C.;
d) distillation range, 183-194° C. and flashpoint, 64° C.;
e) distillation range, 232-287° C. and flashpoint, 101° C.; and
f) distillation range, 248-295° C. and flashpoint, 107° C.

7. The process according to claim 6, wherein the surfactant is a nonionic surfactant.

8. The process according to claim 6 wherein the undesired vegetative growth is one or more species of wild oats (genus Avena, e.g., Avena barbata, Avena brevis, Avena fatua, Avena occidentalis, Avena pubescens, Avena pratensis, Avena spicata, Avena sterilis); or, one or more species of ryegrass (genus Lolium, e.g., Lolium canariense, Lolium edwardii, Lolium multiflorum, Lolium perenne, Lolium persicum, Lolium remotum, Lolium rigidum, Lolium temulentum); or, one or more species of Alopecurus myosuroides; or, one or more species of brome or brome grasses (e.g., genus Bromoeae, i.e., Bromus alopecuros, Bromus anomalus).
